(19) United States
(12) Patent Application Publication
(10) Pub. No.: US 2011/0025641 A1
(43) Pub. Date: Feb. 3, 2011

(54) TOUCH SCREEN APPLIED TO ELECTRONIC APPARATUS

(75) Inventors: Chih-Wei Chen, Taipei County (TW); Wei-Kai Cheng, Hsinchu City (TW)

Correspondence Address: NORTH AMERICA INTELLECTUAL PROPERTY CORPORATION, P.O. BOX 506, MERRIFIELD, VA, 22116, US

(73) Assignee: CANDO CORPORATION, Hsinchu County (TW)

(21) Appl. No.: 12/830,347

(22) Filed: Jul. 4, 2010

(30) Foreign Application Priority Data
Aug. 3, 2009 (TW) 098126063

(51) Int. Cl. G06F 3/045

(52) U.S. Cl. 345/174

(57) ABSTRACT

A touch screen includes a substrate, a plurality of conductive areas and a controller. The conductive areas are disposed on the substrate. The controller is electrically connected to the conductive areas. When one of the conductive areas is touched, the controller determines a coordinate where the touched conductive area is located on the substrate according to the capacitance change of the touched conductive area.

### BACKGROUND OF THE INVENTION

1. Field of the Invention

The invention relates to an electronic apparatus equipped with a touch screen and, more particularly, to a touch screen capable of achieving single touch or multi-touch operation without complicated logic calculation.

2. Description of the Prior Art

Touch screens nowadays are gaining popularity for numerous applications including point-of-information kiosks, vending, electronic catalogs, in-store locators, corporate training, gaming, banking/financial transactions, ticket sales, and the like. A touch screen generally employs one of four types of touch technologies: capacitive, resistive, optics, and surface acoustic wave (SAW), wherein the capacitive and resistive screens are more popular than others.

By way of illustration, a resistive screen is formed of a sandwich of Mylar and plastic or glass separated by substantially transparent elastic spacers. The inside surfaces of the sandwich are coated with a uniform transparent thin film, such as a conductive layer. In operation, a voltage is alternately applied along horizontal and vertical axes of the screen. When a user depresses the Mylar overlay so that its conductive layer contacts the energized layer, the resulting voltage is sensed and transmitted to a controller that converts the signal to an indication of touch location.

In a capacitive type of touch screen, a glass panel is coated with a conductive coating that is fused into the glass. The coating is connected to electrodes located at edges of the screen. Each electrode is connected to controller circuit. When a user touches the screen, the body of the user causes capacitance change in the touch screen. The capacitance change causes the controller to have differentials, and the differentials are converted into a corresponding X-Y coordinate.

However, the manufacturing processes for the capacitive and resistive screens are complicated. Furthermore, most of current touch screens can only achieve single touch operation. For multi-touch operation, the logic calculation will get very complicated and the cost of hardware circuit will increase correspondingly.

### SUMMARY OF THE INVENTION

Therefore, an objective of the invention is to provide a touch screen applied to an electronic apparatus. The touch screen is capable of achieving single touch or multi-touch operation without complicated logic calculation, so as to solve the aforesaid problems.

According to an embodiment, a touch screen of the invention comprises a substrate, a plurality of conductive areas and a controller. The conductive areas are disposed on the substrate. The controller electrically connects to each of the conductive areas. When one of the conductive areas is touched, the controller determines a coordinate where the touched conductive area is located on the substrate according to capacitance change of the touched conductive area.

According to another embodiment, an electronic apparatus of the invention comprises a casing and a touch screen. The touch screen is disposed on the casing. The touch screen comprises a substrate, a plurality of conductive areas and a controller. The conductive areas are disposed on the substrate. The controller electrically connects to each of the conductive areas. When one of the conductive areas is touched, the controller determines a coordinate where the touched conductive area is located on the substrate according to capacitance change of the touched conductive area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an electronic apparatus according to an embodiment of the invention.

FIG. 2 is an exploded view illustrating the touch screen.

FIG. 3 is a front view illustrating the touch screen.

FIG. 4 is a schematic diagram illustrating the conductive areas being touched.

FIG. 5 is a timing chart illustrating capacitance change of the conductive areas.

FIG. 6 is a schematic diagram illustrating the fingers moving over the substrate from inside to outside.

FIG. 7 is a schematic diagram illustrating the image being zoomed in.

FIG. 8 is a schematic diagram illustrating the fingers moving over the substrate horizontally.

FIG. 9 is a schematic diagram illustrating the image being rotated counterclockwise.

FIG. 10 is a front view illustrating a touch screen according to another embodiment of the invention.

### DETAILED DESCRIPTION

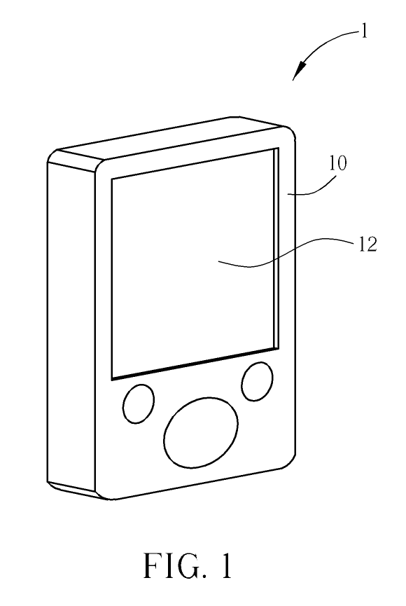

Referring to FIG. 1, FIG. 1 is a schematic diagram illustrating an electronic apparatus 1 according to an embodiment of the invention. As shown in FIG. 1, the electronic apparatus 1 comprises a casing 10 and a touch screen 12. In practical applications, the electronic apparatus 1 can be mobile phone, personal digital assistant (PDA), or other electronic apparatuses equipped with the touch screen 12. In general, there are also some software or hardware, such as central processing unit (CPU), memory, storage device, battery for supplying power, operating system and so on, disposed in the casing 10 of the electronic apparatus 1.

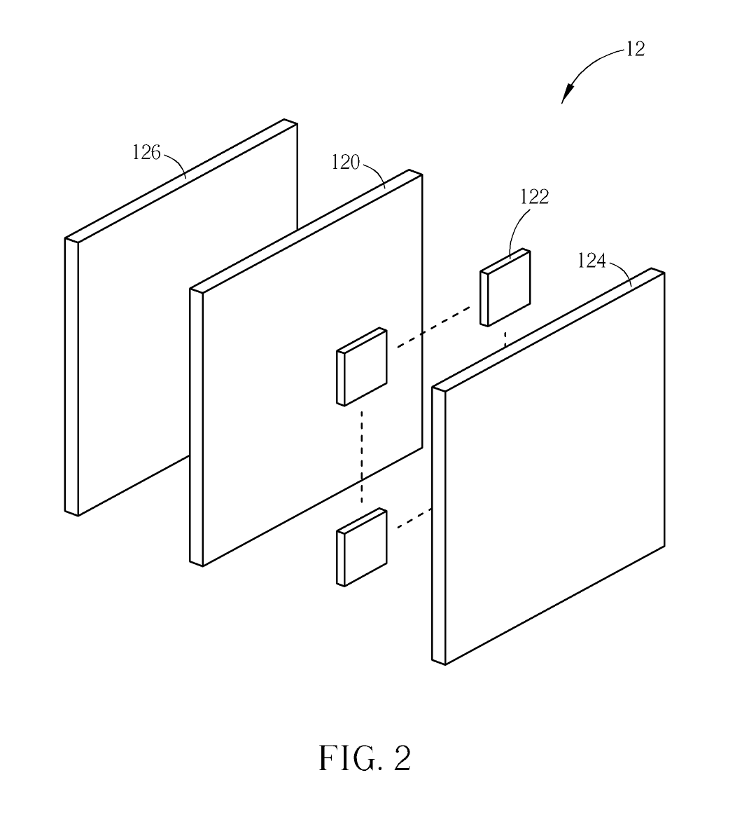

Referring to FIG. 2, FIG. 2 is an exploded view illustrating the touch screen 12. As shown in FIG. 2, the touch screen 12 comprises a substrate 120, a plurality of conductive areas 122, a protective layer 124 and a conductive layer 126. In practical applications, the substrate 120 can be, but not limited to, a glass substrate, the conductive areas 122 and the conductive layer 126 can be made of, but not limited to, indium tin oxide (ITO), and the protective layer 124 can be made of, but not limited to, silicon dioxide (SiO2). To manufacture the touch screen 12, the conductive areas 122 and the conductive layer 126 are coated on opposite sides of the substrate 120 first, and then the protective layer 124 is disposed on the substrate 120 and covers the conductive areas 122. The protective layer 124 can prevent the conductive areas 122 from being damaged during operation and the conductive layer 126 can achieve electromagnetic shielding so as to reduce noise.

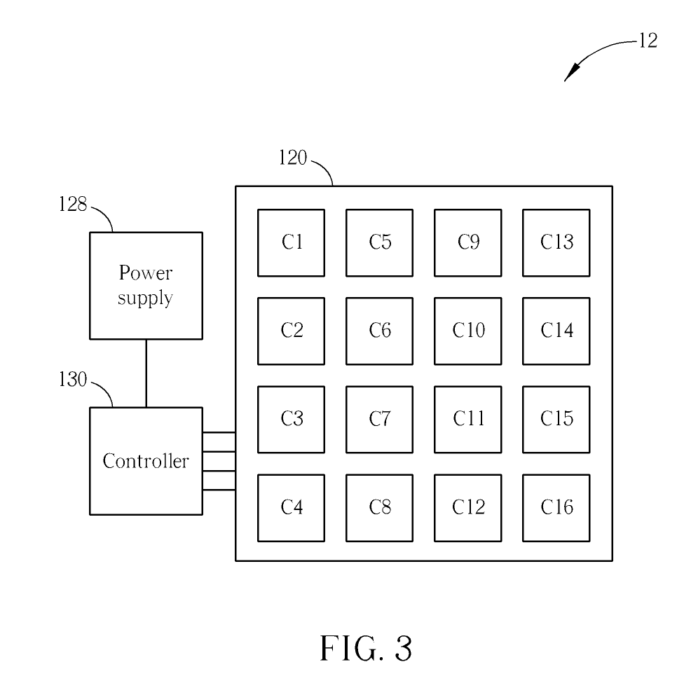

Referring to FIG. 3, FIG. 3 is a front view illustrating the touch screen 12. As show in FIG. 3, the touch screen 12 comprises sixteen conductive areas C1-C16, which are arranged in 4*4 matrix. In this embodiment, each of the conductive areas C1-C16 represents one single touch button. It should be noted that the number of conductive areas of the invention may increase or decrease based on practical applications and is not limited to sixteen shown in FIG. 3. Furthermore, except the aforesaid elements shown in FIG. 2, the touch screen 12 can further comprise a power supply 128 and a controller 130. The power supply 128 is electrically connected to the controller 130 and the controller is electrically connected to each of the conductive areas C1-C16. The power supply 128 supplies power to the controller 130. The controller 130 outputs driving signals to each of the conductive areas C1-C16. When one of the conductive areas C1-C16 is touched, the controller 130 senses the signals and determines a coordinate where the touched conductive area is located on the substrate 120 according to capacitance change of the touched conductive area.

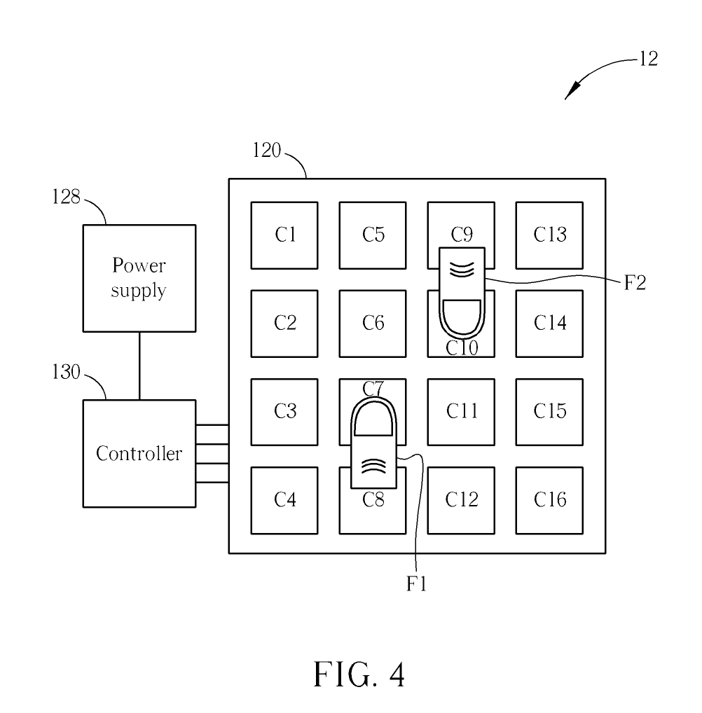

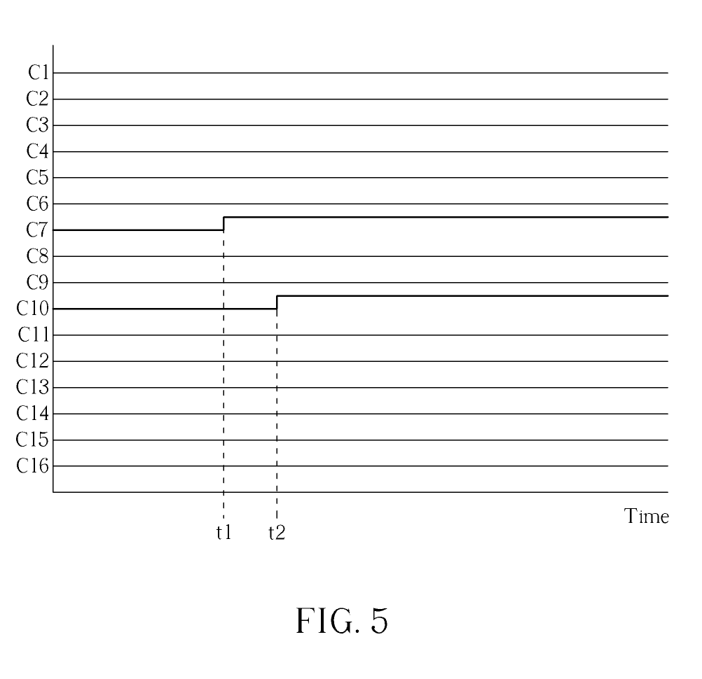

Referring to FIGS. 4 and 5, FIG. 4 is a schematic diagram illustrating the conductive areas C7 and C10 being touched, and FIG. 5 is a timing chart illustrating capacitance change of the conductive areas C1-C16. As shown in FIGS. 4 and 5, when a user (not shown) uses finger F1 to touch the conductive area C7 at time t1, there will be a capacitance coupling between the finger F1 and the conductive area C7 and the finger F1 will absorb a little current, so as to cause capacitance change of the conductive area C7. At this time, the controller 130 can determine a coordinate where the touched conductive area C7 is located on the substrate 120 according to the capacitance change of the touched conductive area C7. Similarly, when the user uses another finger F2 to touch the conductive area C10 at time t2, there will be also a capacitance coupling between the finger F2 and the conductive area C10 and the finger F2 will absorb a little current, so as to cause capacitance change of the conductive area C10. At this time, the controller 130 can determine a coordinate where the touched conductive area C10 is located on the substrate 120 according to the capacitance change of the touched conductive area C10. In other words, since each of the conductive areas C1-C16 shown in FIG. 4 represents one single touch button, provided that the system knows absolute coordinate of each conductive area C1-C16 on the substrate 120 in advance, the controller can easily determine a touch position where the user touches the substrate 120 according to the capacitance change of the touched conductive area while the user touches any one of the conductive areas C1-C16 and then performs a predetermined function correspondingly.

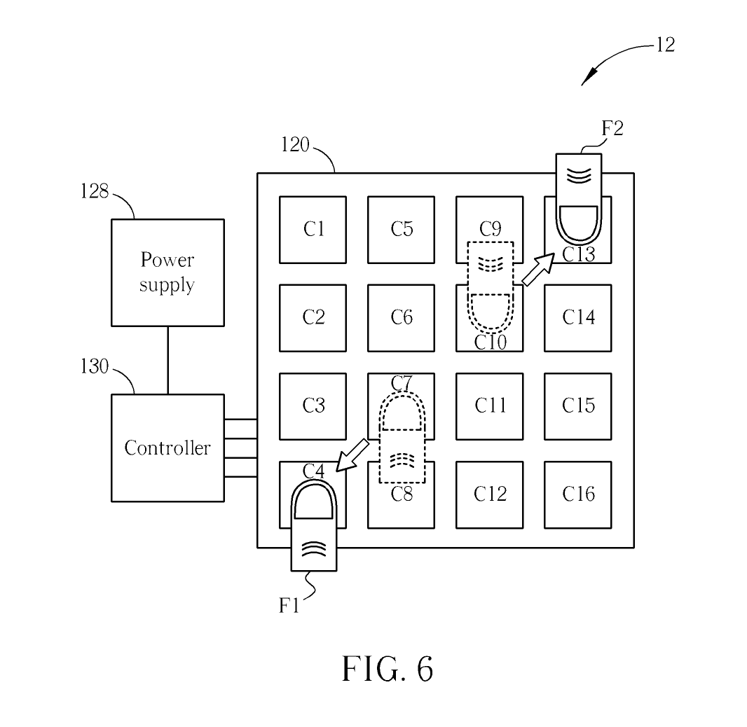

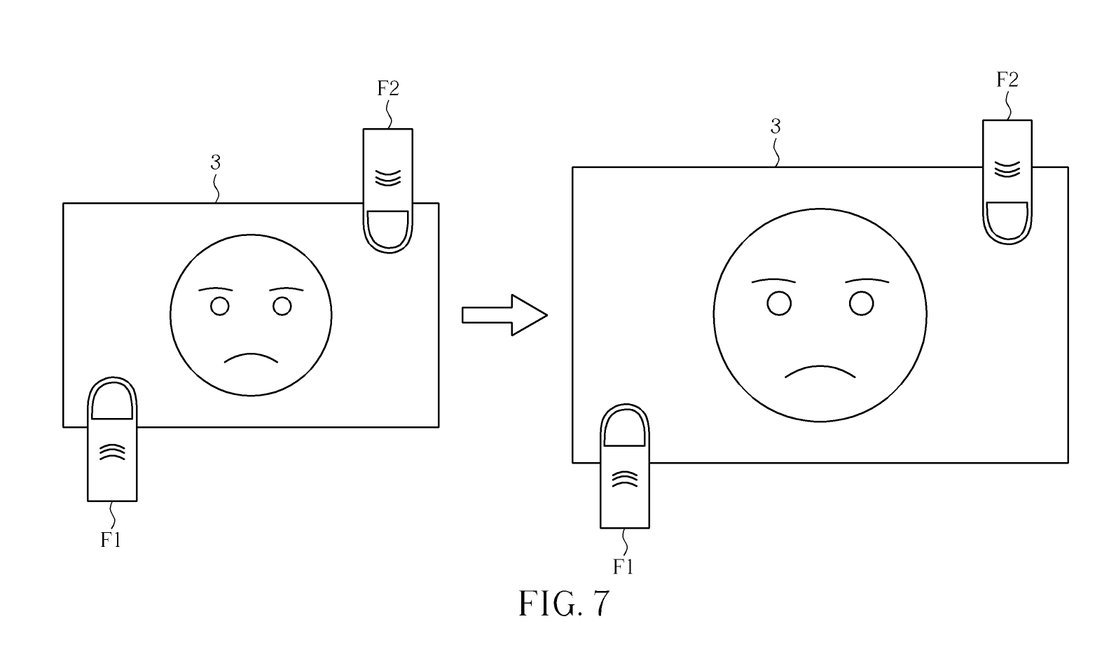

The invention may perform various predetermined functions according to trajectories of the fingers F1 and F2 moving over the substrate 120. For example, an image shown on the screen will be zoomed in when the fingers F1 and F2 move over the substrate 120 from inside to outside. Referring to FIGS. 6 and 7, FIG. 6 is a schematic diagram illustrating the fingers F1 and F2 moving over the substrate 120 from inside to outside, and FIG. 7 is a schematic diagram illustrating the image 3 being zoomed in. As shown in FIG. 6, the image 3 shown in the left of FIG. 7 will be zoomed in to the image 3 shown in the right of FIG. 7 when the fingers F1 and F2 moves from the conductive areas C7 and C10 to C4 and C13 respectively and outwardly. On the other hand, if the user wants to zoom out the image 3 shown in the right of FIG. 7 to the image 3 shown in the left of FIG. 7, the user only has to move the fingers F1 and F2 from the conductive areas C4 and C13 to C7 and C10 respectively and inwardly.

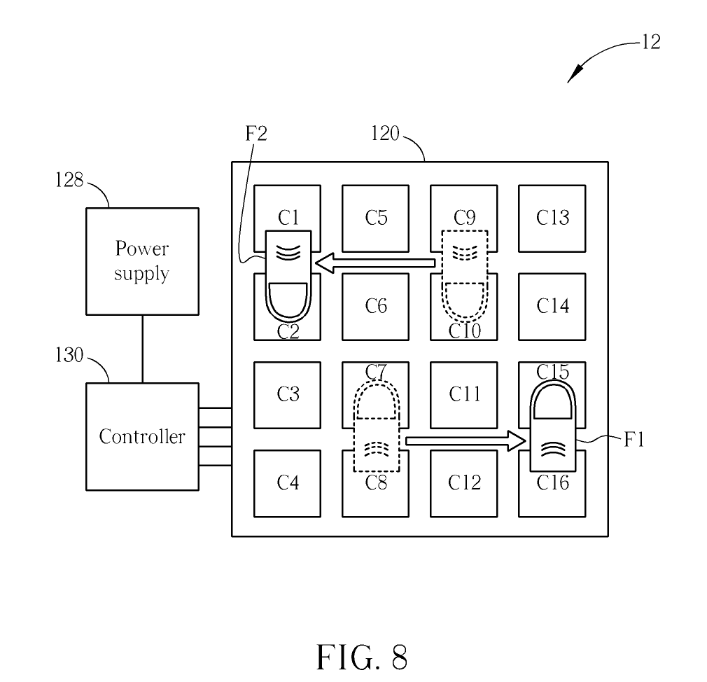

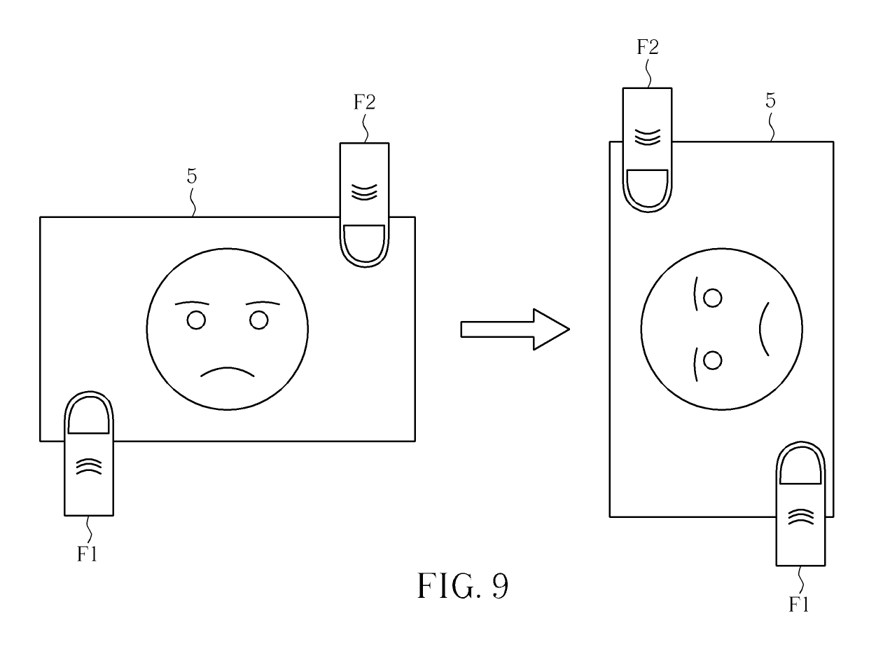

Moreover, the invention may perform function of rotating image when the fingers F1 and F2 move over the substrate 120 horizontally. Referring to FIGS. 8 and 9, FIG. 8 is a schematic diagram illustrating the fingers F1 and F2 moving over the substrate 120 horizontally, and FIG. 9 is a schematic diagram illustrating the image 5 being rotated counterclockwise. As shown in FIG. 8, the image 5 shown in the left of FIG. 9 is rotated counterclockwise to the image 5 shown in the right of FIG. 9 when the fingers F1 and F2 moves from the conductive areas C7 and C10 to C15 and C2 through C11 and C6 respectively and horizontally. On the other hand, if the user wants to rotate the image 5 shown in the right of FIG. 9 clockwise to the image 5 shown in the left of FIG. 9, the user only has to move the fingers F1 and F2 from the conductive areas C15 and C2 to C7 and C10 through C11 and C6 respectively and horizontally.

It should be noted that, except the aforesaid functions of zooming in/out image and rotating image, the invention still can achieve other touch functions by using corresponding software and it depends upon practical applications.

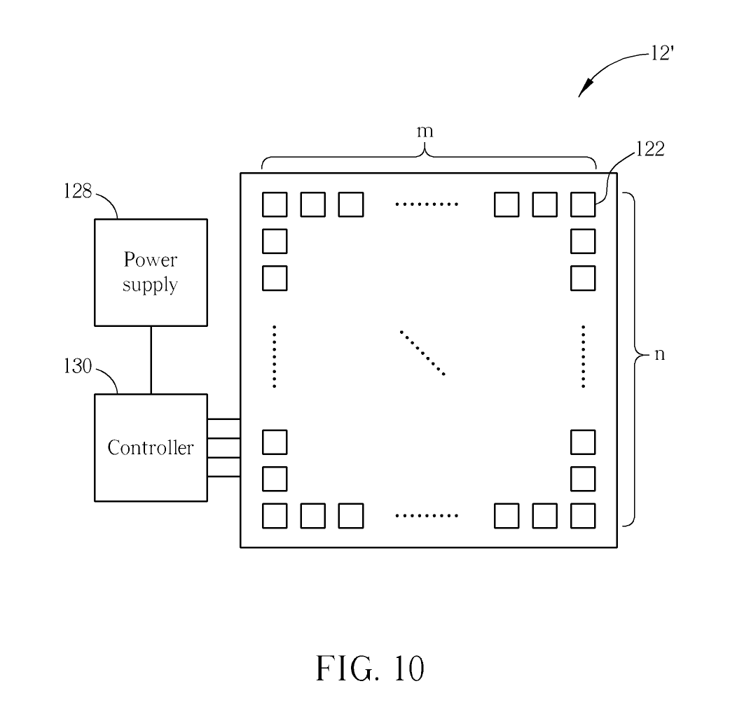

Referring to FIG. 10, FIG. 10 is a front view illustrating a touch screen 12′ according to another embodiment of the invention. As shown in FIG. 10, the touch screen 12′ comprises m*n conductive areas 122 arranged in matrix. The main difference between the touch screen 12′ and the aforesaid touch screen 12 is that the touch screen 12′ comprises more conductive areas 122 than the touch screen 12 and the conductive areas 122 are arranged more compactly, so as to improve resolution of the touch screen 12′. Accordingly, the user also can utilize the touch screen 12′ to perform functions of cursor, hand-writing or the like. It should be noted that the elements with the same numerals in FIGS. 10 and 3 have the same structure and principle and the related description does not be described here again.

Compared to prior art, since each of the conductive areas of the touch screen of the invention represents one single touch button, provided that the system knows absolute coordinate of each conductive area relative to the substrate in advance, the controller can easily determine a touch coordinate where the user touches the substrate according to the capacitance change of the touched conductive area while the user touches any one of the conductive areas and then performs a predetermined function correspondingly. Accordingly, the invention can achieve single touch or multi-touch operation easily without complicated logic calculation

Those skilled in the art will readily observe that numerous modifications and alterations of the device and method may be made while retaining the teachings of the invention.

What is claimed is:

1. A touch screen comprising:
a substrate;
a plurality of conductive areas disposed on the substrate; and
a controller electrically connected to each of the conductive areas, when one of the conductive areas is touched, the controller determining a coordinate where the touched conductive area is located on the substrate according to capacitance change of the touched conductive area.

2. The touch screen of claim 1, further comprising a power supply electrically connected to the controller and used for supplying power to the controller.

3. The touch screen of claim 1, wherein the conductive areas are arranged in a matrix.

4. The touch screen of claim 1, wherein the substrate is a glass substrate.

5. The touch screen of claim 1, wherein the conductive areas are made of indium tin oxide.

6. The touch screen of claim 1, further comprising a protective layer disposed on the substrate, wherein the protective layer covers the plurality of conductive areas.

7. The touch screen of claim 1, wherein the protective layer is made of silicon dioxide.

8. An electronic apparatus comprising:
a casing; and
a touch screen disposed on the casing, the touch screen comprising:
a substrate;
a plurality of conductive areas disposed on the substrate; and
a controller electrically connected to the conductive areas, when one of the conductive areas is touched, the controller determining a coordinate where the touched conductive area is located on the substrate according to capacitance change of the touched conductive area.

9. The electronic apparatus of claim 8, further comprising a power supply electrically connected to the controller and used for supplying power to the controller.

10. The electronic apparatus of claim 8, wherein the conductive areas are arranged in a matrix.

11. The electronic apparatus of claim 8, wherein the substrate is a glass substrate.

12. The electronic apparatus of claim 8, wherein the conductive areas are made of indium tin oxide.

13. The electronic apparatus of claim 8, wherein the touch screen further comprises a protective layer disposed on the substrate, and the protective layer covers the plurality of conductive areas.

14. The electronic apparatus of claim 13, wherein the protective layer is made of silicon dioxide.
